(19) United States
(12) Patent Application Publication
(10) Pub. No.: US 2011/0196554 A1
(43) Pub. Date: Aug. 11, 2011

(54) Method and Control Unit for Automatic Selection of an Operating Mode for a Vehicle With Fuel Cells

(75) Inventors: Uwe Limbeck, Kirchheim (DE); Sven Schmalzriedt, Ostfildern (DE)

(73) Assignees: Daimler AG, Stuttgart (DE); Ford Global Technologies LLC, Dearborn, MI (US)

(21) Appl. No.: 12/678,956

(22) PCT Filed: Jul. 23, 2008
(86) PCT No.: PCT/EP2008/006035

§ 371 Date: Mar. 18, 2010

(30) Foreign Application Priority Data
Sep. 19, 2007 (DE) 102007044760.6

(51) Int. Cl. G06F 19/00

(52) U.S. Cl. 701/22

(57) ABSTRACT

The invention relates to a method for automatic selection of an operating mode (S, W) for a vehicle with a fuel cell system (1), in which at least one first operating mode (S) and one second operating mode (W) are provided, wherein the operating mode (S, W) is defined taking into account a current calendar date (D) and/or taking into account a weather forecast (V) obtained from a data network, and/or taking account of a current environmental air pressure (p).

The invention relates to a method and a control unit for automatic selection of an operating mode for a vehicle with fuel cells.

A long life, high energy efficiency and short starting times are desirable for fuel cell systems in vehicles. Depending on the environmental conditions, conflicts between objects can occur in this case, in which one of the stated objectives must be subordinated to one of the other objectives. For example, a summer mode can be provided in which the fuel cell system is operated such that both the life and the energy generated are maximized, although this is not suitable for operation in low outside temperatures, for example in the event of frost. A winter mode can be provided for this situation in which, for example, the fuel cell system is heated in order to avoid icing. Heating requires energy, which is not available as traction energy for the vehicle. For convenience and operational reliability reasons, it is desirable for a decision between the summer mode and the winter mode to be made automatically in the vehicle.

DE 603 00 849 T2 discloses a fuel cell system in which outside temperatures which have previously been measured are stored in a controller, and an input appliance can supply the controller with a planned starting time for the next vehicle start. A temperature prediction for the planned starting time is calculated on the basis of the previously measured outside temperatures, and the amount of energy required to defrost the fuel cell system is determined on the basis of this, if necessary. The accuracy of a temperature prediction such as this from previously measured outside temperatures is, however, inadequate.

One object of the invention is therefore to specify a better method and a better control unit for automatic selection of an operating mode for a vehicle with fuel cells.

According to the invention, the object is achieved by a method having the features of claim 1, and by a control unit having the features of claim 10.

Advantageous refinements are the subject matter of the dependent claims.

In the method according to the invention for automatic selection of an operating mode for a vehicle with a fuel cell system, at least one first operating mode, in particular for summer operation and one second operating mode, in particular for winter operation, are provided. The operating mode is defined taking into account a current calendar date and/or taking into account a weather fore cast obtained from a data network, and/or taking account of a current environmental air pressure. In particular, a combination of at least two of the parameters calendar date, weather forecast, environmental air pressure results in a robust capability to decide the operating mode. The method is implemented in particular in a control unit for a fuel cell in a vehicle, to which control unit the current calendar date from a system clock and/or the weather forecast from a data network and/or the current environmental air pressure from a pressure sensor can be supplied.

The selection of the operating mode preferably takes account of a current position of the vehicle, which can be supplied to the control unit from a position finding system, for example a GPS system. This allows specific prediction of the environmental conditions to be expected, on the basis of the weather forecast for the precise location of the vehicle. In the same way as system clocks and pressure sensors, position finding systems for navigation of vehicles are currently already provided in many vehicles, so that these components generally do not need to be additionally installed in a vehicle, so that virtually no additional costs are incurred.

The second operating mode for winter operation is preferably selected when one of the following conditions is satisfied:
the current calendar date is between November 15 and March 15, and the current environmental air pressure is higher than 900 mbar,
the current calendar date is between October 15 and April 15, and the current environmental air pressure is between 800 mbar and 900 mbar,
the current calendar date is between September 15 and May 15, and the current environmental air pressure is between 700 mbar and 800 mbar,
the current environmental air pressure is below 700 mbar.

The first operating mode for summer operation is selected in all other cases. This method is based on a specific climatic zone with reproducible temperature conditions and, by measuring the environmental air pressure, additionally takes account of the altitude, as determined implicitly in this way, of the location of the vehicle above sea level, thus likewise resulting in a typical temperature profile.

If the method is based on the weather forecast, the weather forecast data is preferably obtained by a wire-free link from the Internet. New vehicles are increasingly being equipped with the communication technology required for this purpose. The widespread use of this communication technology and the trend to decreasing connection costs for access to the Internet mean that only minor additional costs are incurred in this case as well.

A time for the next planned start of the vehicle is advantageously notified to the control unit for reference or for evaluation of the weather forecast data, by means of a suitable input device. In this case, by way of example, on completion of the current journey, the vehicle driver can enter the time when he next wishes to use the vehicle. This allows the operating mode to be selected to be matched more precisely to the weather forecast. This may also make it possible to reduce the volume of data to be downloaded, since the weather forecast data is then required only for the stated time.

Exemplary embodiments of the invention will be explained in more detail in the following text with reference to drawings, in which:

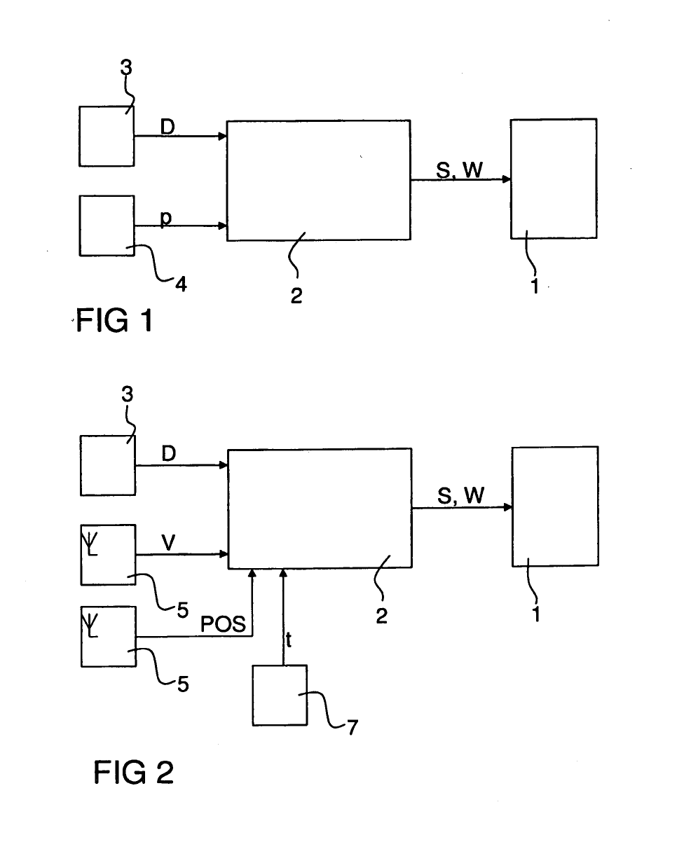

FIG. 1 shows a first embodiment of a fuel cell system with a control unit, and

FIG. 2 shows a further embodiment of a fuel cell system with a control unit.

Mutually corresponding parts are provided with the same reference symbols in all the figures.

FIG. 1 shows a first embodiment of a fuel cell system 1 with a control unit 2. The control unit 2 defines a first operating mode S for summer operation and a second operating mode W for winter operation for the fuel cell system 1. The decision on the operating mode S, W is made by the control unit 2 on the basis of the current calendar date D, which is supplied to it from a system clock 3, and on the basis of the current environmental air pressure p, which is made available to it from a pressure sensor 4.

The second operating mode W is selected when one of the following conditions is satisfied:
the current calendar date D is between November 15 and March 15, and the current environmental air pressure p is higher than 900 mbar,
the current calendar date D is between October 15 and April 15, and the current environmental air pressure p is between 800 mbar and 900 mbar,
the current calendar date D is between September 15 and May 15, and the current environmental air pressure p is between 700 mbar and 800 mbar,
the current environmental air pressure p is below 700 mbar.

The first operating mode S for summer operation is selected in all other cases.

Other date ranges and air-pressure ranges can be defined, particularly when the vehicle is intended to be operated in a different climatic zone.

FIG. 2 shows a further embodiment of a fuel cell system 1 with a control unit 2. The control unit 2 defines a first operating mode S for summer operation and a second operating mode W for winter operation for the fuel cell system 1. The decision on the operating mode S, W to be selected is made by the control unit 2 on the basis of the current calendar date D, which is supplied to it from a system clock 3. It also takes account of the weather forecast V, which is obtained via a cordless communication system 5 from a data network, for example the Internet. The weather forecast V is in this case produced for a current position POS of the vehicle determined by means of a position finding system 6, either in the control unit 2 itself or in a remote data processing unit, which provides the weather forecast V, in the Internet (not shown).

An input apparatus 7 offers the vehicle driver the capability to enter the time t of the next planned start of the vehicle. The weather forecast V can then be restricted to this time t.

Features of the embodiments illustrated in FIGS. 1 and 2 can be combined with one another.

The system clock 3 may be integrated in the control unit 2.

The fuel cell system 1 is started identically independently of the selected operating mode S, W. In contrast, the fuel cell system 1 is operated differently in the two operating modes S, W. When the criteria for the second operating mode W (=winter mode) are satisfied and the second operating mode W has been selected, the fuel cell system 1 is operated largely dry at higher operating temperatures, for example by heating, in order to avoid icing when the outside temperatures are low. This second operating mode W leads to higher consumption and to a reduced maximum power. In the first operating mode S (=summer mode), in contrast, the fuel cell system 1 is operated so as to maximize both the life and the energy that is produced. For this purpose, the fuel cell system 1 is operated at lower temperatures and thus largely moist.

### LIST OF REFERENCE SYMBOLS

1 Fuel cell system
2 Control unit
3 System clock
4 Pressure sensor
5 Communication unit
6 Position finding system
7 Input device
D Current calendar date
p Current environmental air pressure
POS Current position
S First operating mode
t Time of the next planned start of the vehicle
V Weather forecast
W Second operating mode

1. A method for automatic selection of an operating mode (S, W) for a vehicle with a fuel cell system (1), in which at least one first operating mode (S) and one second operating mode (W) are provided, characterized in that the operating mode (S, W) is defined taking into account a current calendar date (D) and/or taking into account a weather forecast (V) obtained from a data network, and/or taking account of a current environmental air pressure (p).

2. The method as claimed in claim 1, characterized in that, when the operating mode (S, W) is selected, a current position (POS) of the vehicle is taken into account.

3. The method as claimed in one of claim 1 or 2, characterized in that the second operating mode (W) is selected when the current calendar date (D) is between November 15 and March 15 and the current environmental air pressure (p) is greater than 900 mbar.

4. The method as claimed in one of claims 1 to 3, characterized in that the second operating mode (W) is selected when the current calendar date (D) is between October 15 and April 15 and the current environmental air pressure (p) is between 800 mbar and 900 mbar.

5. The method as claimed in one of claims 1 to 4, characterized in that the second operating mode (W) is selected when the current calendar date (D) is between September 15 and May 15 and the current environmental air pressure (p) is between 700 mbar and 800 mbar.

6. The method as claimed in one of claims 1 to 5, characterized in that the second operating mode (W) is selected when the current environmental air pressure (p) is below 700 mbar.

7. The method as claimed in one of claims 1 to 6, characterized in that the Internet is used as the data network.

8. The method as claimed in one of claims 1 to 7, characterized in that a cordless connection is used to the data network.

9. The method as claimed in one of claims 1 to 8, characterized in that an indication of a time (t) of a next planned start of the vehicle is taken into account in order to evaluate the weather forecast (V).

10. A control unit (2) for a fuel cell system (1) for a vehicle, by means of which an operating mode (S, W) can be defined for the fuel cell system (2) with at least one first operating mode (S) and one second operating mode (W) being provided, characterized in that the control unit (2) can be supplied with a current calendar date (D) from a system clock (3) and/or with a weather forecast (V) from a data network and/or a current environmental air pressure (p) from a pressure sensor (4) and can thus influence the definition of the operating mode (S, W).

11. The control unit (2) as claimed in claim 10, characterized in that the control unit (2) can be supplied with a current position (POS) for the vehicle from a position finding system (6), and can thus influence the definition of the operating mode (S, W).

12. The control unit (2) as claimed in one of claim 10 or 11, characterized in that the control unit (2) can be supplied with the time (t) of the next planned start of the vehicle from an input device (7), and can thus influence the definition of the operating mode (S, W).
